(19) United States
(12) Patent Application Publication
(10) Pub. No.: US 2008/0080804 A1
(43) Pub. Date: Apr. 3, 2008

(54) TUNABLE WAVEGUIDE BRAGG GRATING DEVICE

(75) Inventors: Min Su Kim, Daejeon (KR); Jung Jin Ju, Daejeon (KR); Seung Koo Park, Daejeon (KR); Jong Bae Kim, Daejeon (KR); Myung Hyun Lee, Daejeon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon (KR)

(21) Appl. No.: 11/864,224

(22) Filed: Sep. 28, 2007

(30) Foreign Application Priority Data
Sep. 29, 2006 (KR) 10-2006-0096325

(51) Int. Cl. G02F 1/295

(52) U.S. Cl. 385/4

(57) ABSTRACT

Provided is a tunable waveguide Bragg grating device, which includes: a waveguide through which incident light can travel; a Bragg grating formed in at least one region of the waveguide; and at least one thermal tuning unit formed at a position displaced from the central line of a waveguide core along the length direction of the waveguide core. Accordingly, it is possible to tune a reflection wavelength band and a group delay characteristic of the waveguide Bragg grating device in a variety of ways. It is also possible to manufacture a multiple channel tunable waveguide Bragg grating device with ease by applying an array arrangement, which is advantageous in constructing an integrated optical module.

### CROSS-REFERENCE TO RELATED APPLICATION

This application claims priority to and the benefit of Korean Patent Application No. 2006-0096325, filed Sep. 29, 2006, the disclosure of which is incorporated herein by reference in its entirety.

### BACKGROUND

1. Field of the Invention

The present invention relates to a tunable waveguide Bragg grating device, and more particularly, to a tunable waveguide Bragg grating device that is advantageous for embodying an integrated optical module and is capable of effectively tuning a reflection wavelength band and a group delay characteristic in the reflection wavelength band caused by the Bragg grating on the basis of thermo-optic effects.

2. Discussion of Related Art

Since a Bragg grating device generally has an excellent characteristic of selectively reflecting or diffracting a narrow wavelength band, it has a variety of applications, such as in a filter, a resonator, a coupler, a diffracting element, a sensor, an optical pulse compressor and a dispersion compensator. Also, the Bragg grating device is actively applied in the fields of optical communication and sensor technology in the form of a waveguide suitable for embodying an integrated optical module.

The waveguide-type Bragg grating device makes use of the fact that, among various wavelength components propagating through the waveguide, only those within a narrow band around a specific wavelength, which satisfies the Bragg reflection condition given by λ_{B}=2NΛ, are reflected in the reverse direction. In the above condition, λ_{B} denotes a central wavelength of the reflection band, N denotes a modal effective refractive index for the relevant wavelength in the waveguide, and Λ denotes a period of the Bragg grating.

When a waveguide Bragg grating device has a constant effective refractive index and a uniform period, the reflection bandwidth decreases without any change of central wavelength and reflectivity increases gradually as the length of the Bragg grating region increases. In this case, a group delay spectrum as a function of wavelength remains almost constant in the reflection band. Meanwhile, in the case of a chirped waveguide Bragg grating device whose effective refractive index or period decreases or increases gradually in the length direction, different wavelength components are reflected at different positions along the chirped waveguide Bragg grating device due to the change of the Bragg reflection condition in the length direction. Accordingly, it is possible to control the reflection band and group delay characteristic.

In addition, when thermo-optic effects are applied to the waveguide Bragg grating device, it is possible to modulate the reflection band or group delay characteristic in a variety of ways. Recently, efforts have been made to use a chirped fiber Bragg grating to compensate for a dispersion effect occurring in high-speed optical communication. Further, on the basis of polymer materials, which have a great advantage in integrating optical devices and whose thermo-optic coefficients are much higher than that of silica optical fiber, technology for manufacturing a Bragg grating device with the structure of a planar waveguide and tuning a reflection band and a group delay characteristic by thermo-optic effects is under development.

Hereinafter, a planar waveguide Bragg grating device that can be tuned using thermo-optic effects is described with reference to the drawings.

FIG. 1a is a plan view of a conventional tunable waveguide Bragg grating device in which a reflection band can be tuned using thermo-optic effects, and FIG. 1b is a cross-sectional view taken along line A-A′ of FIG. 1a.

The tunable waveguide Bragg grating device 100 shown in FIGS. 1a and 1b is comprised of a waveguide Bragg grating region 130 formed on a substrate 110 and a thermal tuning means 141 formed on the waveguide Bragg grating region. The waveguide Bragg grating region 130 constituting the waveguide Bragg grating device 100 is comprised of a waveguide core 131 formed on the substrate 110, a cladding region 133 surrounding the waveguide core 131, and a Bragg grating 132 with a uniform period formed on the waveguide core 131. Further, the thermal tuning means 141 preferably employs a thin film heater and has a pair of electrodes 143 connected thereto to supply power needed for thermal tuning. In the case of a conventional tunable waveguide Bragg grating device having such a configuration, a temperature change in the device caused by the thermal tuning means 141 changes the effective refractive index of the waveguide, thereby shifting the reflection band.

FIG. 2a is a plan view of a conventional tunable waveguide Bragg grating device employing a method of tuning a reflection band and a group delay characteristic using thermo-optic effects, and FIG. 2b is a cross-sectional view taken along line B-B′ of FIG. 2a.

FIG. 2a illustrates a technology disclosed in Korean patent application No. 10-2006-0031487, in which a tunable waveguide Bragg grating device 200 is comprised of a waveguide Bragg grating region 130 formed on a substrate 110, and a thermal tuning means 141 formed on the waveguide Bragg grating region 130, just like the structure shown in FIG. 1a. The tunable waveguide Bragg grating device 200 further includes a temperature control means 150 under the substrate 110. In the structure, the waveguide core 131 is tapered in a region where the Bragg grating 132 is applied, so that a specific group delay characteristic is generated by the chirp effect due to the change of effective refractive index along the length of the waveguide core 131. The thermal tuning means 141 positioned on the waveguide Bragg grating region 130 also has a tapered structure and is connected to a pair of electrodes 143 at each end. Therefore, by adjusting the temperature distribution in the device according to the shape of the thermal tuning means 141, we can tune the group delay characteristic of the waveguide Bragg grating device. Further, the temperature control means 150 serves to shift the reflection band without affecting the group delay characteristic.

### SUMMARY OF THE INVENTION

The present invention is directed to a tunable waveguide Bragg grating device in which a reflection band and a group delay characteristic can be tuned in a variety of ways.

The present invention is also directed to a structure suitable for multiple channel integration of tunable waveguide Bragg grating devices.

One aspect of the present invention provides a tunable waveguide Bragg grating device including: a waveguide through which incident light can travel; a Bragg grating formed in at least one region of the waveguide; and at least one thermal tuning means formed at a position displaced from the central line of a waveguide core along the length direction of the waveguide core.

The waveguide core may have a structure of fixed height and width, or a tapered structure in which the height or width changes in the length direction of the waveguide core. The Bragg grating may be formed inside the waveguide core or in a region where an optical mode traveling in the waveguide can be coupled. Further, the Bragg grating may have a uniform period or has a period chirp along its length direction. An apodization, that is, a gradual decrease of a coupling coefficient of the Bragg grating, may be applied to at least one end of the Bragg grating. The thermal tuning means may employ a thin film heater and may have a structure of fixed height and width, or a tapered structure in which the height or width changes in the length direction of the waveguide core. Further, when there are plural thermal tuning means, at least one pair of the thermal tuning means may have the same taper characteristic and be arranged in opposite directions with respect to the length direction of the waveguide core, or several thermal tuning means may have different taper characteristics and be arranged along the length direction of the waveguide core. Meanwhile, at least one of the thermal tuning means may be formed on a different layer than the waveguide core so that the thermal tuning means can be viewed to at least partially overlap with the waveguide core on a plan view. The tunable waveguide Bragg grating device may further include a temperature control means which is arranged on a different layer than the thermal tuning means to control the overall temperature of the Bragg grating device.

Another aspect of the present invention provides a multiple channel tunable waveguide Bragg grating device including multiple channel structures made by arranging the tunable waveguide Bragg grating devices described above in an array form.

The multiple channel tunable waveguide Bragg grating device may further include trench structures formed between the channels.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1a is a plan view of a conventional tunable waveguide Bragg grating device in which a reflection band can be tuned using thermo-optic effects;

FIG. 1b is a cross-sectional view taken along line A-A′ of FIG. 1a;

FIG. 2a is a plan view of a conventional tunable waveguide Bragg grating device in which a reflection band and a group delay characteristic can be tuned using thermo-optic effects;

FIG. 2b is a cross-sectional view taken along line B-B′ of FIG. 2a;

FIG. 3a is a schematic plan view of a tunable waveguide Bragg grating device in accordance with a first exemplary embodiment of the present invention;

FIG. 3b is a cross-sectional view taken along line C-C′ of FIG. 3a;

FIG. 4a is a schematic plan view illustrating a tunable waveguide Bragg grating device in accordance with a second exemplary embodiment of the present invention;

FIG. 4b is an example of a cross-sectional view taken along line D-D′ of FIG. 4a;

FIG. 5 is a cross-sectional view of a multiple channel tunable waveguide Bragg grating device in accordance with a third exemplary embodiment of the present invention; and

FIG. 6 is a cross-sectional view of a multiple channel tunable waveguide Bragg grating device in accordance with a fourth exemplary embodiment of the present invention.

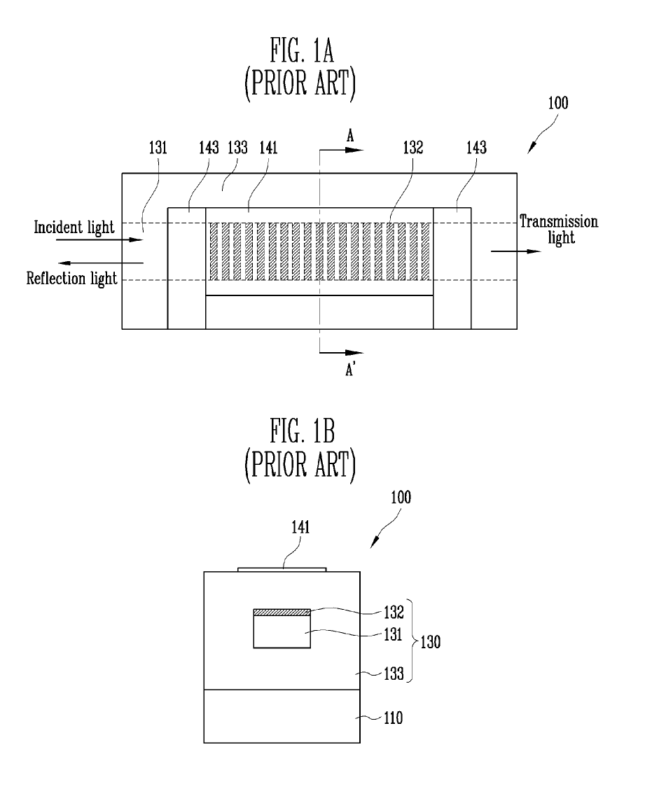

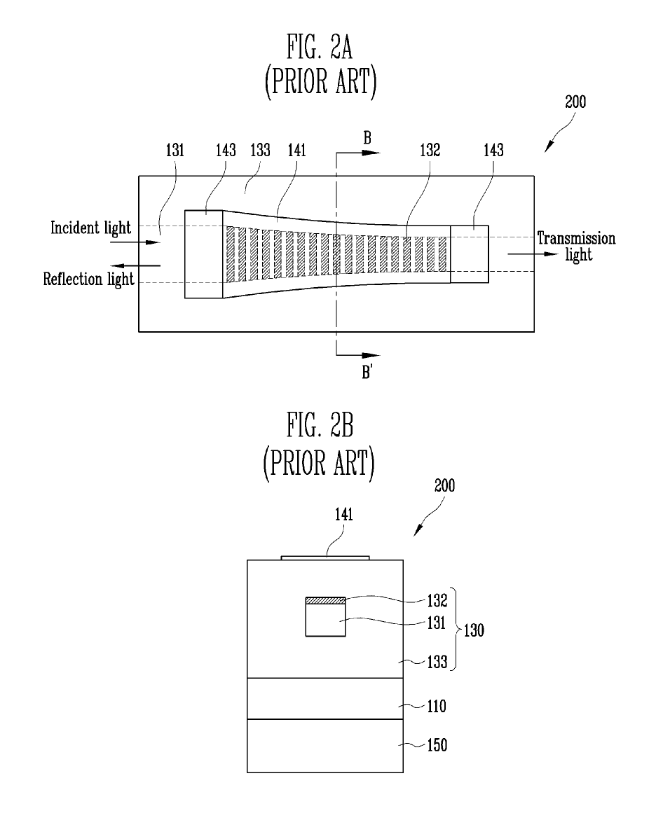

### DETAILED DESCRIPTION OF EXEMPLARY EMBODIMENTS

Hereinafter, exemplary embodiments of the present invention will be described in detail. However, the present invention is not limited to the exemplary embodiments disclosed below, but can be implemented in various forms. The following exemplary embodiments are described to fully enable those of ordinary skill in the art to embody and practice the invention.

### First Exemplary Embodiment

The first exemplary embodiment of the present invention relates to a method of applying a thermal tuning means to tune a reflection band and a group delay characteristic of a waveguide Bragg grating device. In particular, the first exemplary embodiment is characterized in that a thermal tuning means is arranged in a region displaced from the centeral line of the waveguide core, along the length direction of the waveguide. The first exemplary embodiment gives a considerable degree of freedom when selecting a position of the thermal tuning means employed in the tunable waveguide Bragg grating device. So, it forms a basic construction of the present invention capable of obtaining various tuning effects of the reflection band and group delay in other exemplary embodiments of the present invention described below.

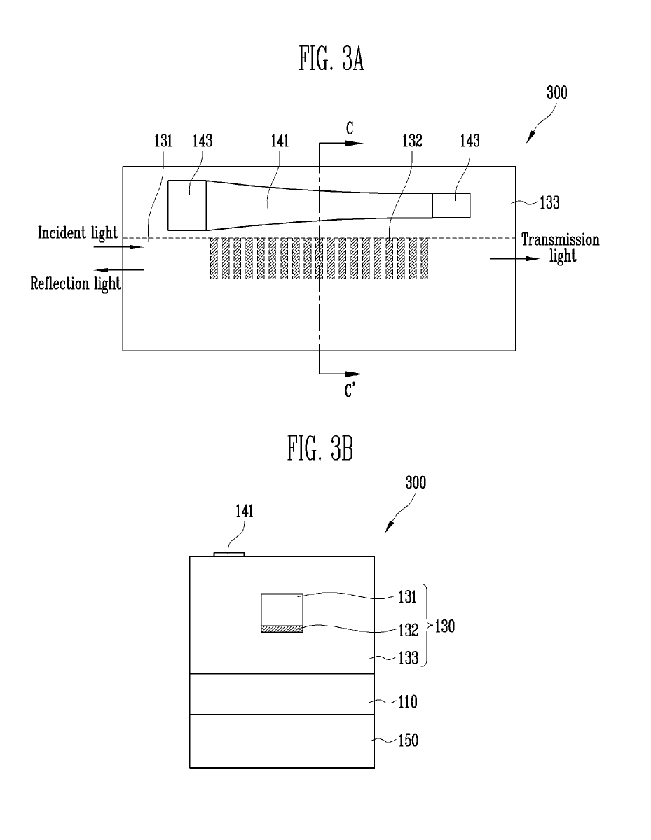

FIG. 3a is a plan view of a tunable waveguide Bragg grating device in accordance with a first exemplary embodiment of the present invention, and FIG. 3b is a cross-sectional view taken along line C-C′ of FIG. 3A.

The tunable waveguide Bragg grating device 300 shown in FIGS. 3a and 3b is comprised of a Bragg grating region 130 formed on a substrate 110, a thermal tuning means 141 formed on the Bragg grating region 130, and a temperature control means 150 formed under the substrate 110. The Bragg grating region 130 is comprised of a waveguide core 131, a Bragg grating 132 which is formed under the waveguide core 131 and has a uniform period, and a cladding layer 133 surrounding the waveguide core 131. The temperature control means 150 performs a temperature tuning function to control the overall operating temperature of the Bragg grating device 300 or to shift a reflection band of it.

Meanwhile, a thermal tuning means 141 is positioned on a different layer than the waveguide core 131, that is, on a cladding layer 133, according to FIG. 3a. And, the thermal tuning means 141 is formed outside the centeral line of the waveguide core 131 and along the length direction of the waveguide core 131. FIG. 3a shows an example in which the thermal tuning means 141 is formed in a tapered shape, and it is generally preferable that the thermal tuning means 141 is a thin film heater. The thermal tuning means 141 is connected to a pair of electrodes 143 formed on both ends of the thermal tuning means 141. So, the thermal tuning means 141 is provided with voltage, current or heat through the pair of the electrodes 143. A temperature distribution in the Bragg grating device formed by the thermal tuning means 141, which is tapered as in FIGS. 3a and 3b, makes variation of the effective refractive index in the length direction of the waveguide core 131, and accordingly it is possible to tune the reflection band and group delay characteristic of the Bragg grating device 300.

The first exemplary embodiment of FIGS. 3a and 3b is not limited to the disclosed structure and can be modified in various ways. FIGS. 3a and 3b show a case in which, for the sake of convenience, a waveguide core 131 of a channel type has uniform width and height, the period of the Bragg grating 132 is uniform, and a thermal tuning means 141 is tapered in width.

However, since the present invention relates to application of the thermal tuning means 141 outside the waveguide core and along the length direction of the waveguide in the Bragg grating device structure, the present invention is not limited to any particular structure or material of the waveguide core 131. Further, the present invention is not limited with respect to tapering of the waveguide core in width or height, tapering of the Bragg grating, chirp or apodization of the Bragg grating, etc. And, the present invention is not limited with respect to the inclusion of a temperature control means 150 or a substrate 110.

As to position and structure of the Bragg grating 132, a surface relief grating formed within region where an optical mode traveling in the waveguide can be coupled, a bulk type grating formed in the waveguide region, a grating formed in a part of the waveguide, and variously modified or extended types of such gratings can be applied. Meanwhile, in addition to the arrangement of the thermal tuning means 141 shown in FIG. 3a, a relative layer arrangement of the thermal tuning means 141 to the waveguide core 131 is not limited whether the thermal tuning means 141 may be placed on an upper, a lower, or the same layer with respect to the waveguide core 131 so long as the thermal tuning means 141 does not pass into the waveguide core 131. Further, the scope of the present invention is not limited whether the thermal tuning means 141 is tapered in width or height and whether the thermal tuning means 141 partially overlaps the waveguide core 131 on a different layer than the thermal tuning means 141. The case of the thermal tuning means 141 not crossing the waveguide core 131 but being arranged almost in parallel to the length direction of the waveguide with a small angle therebetween, and similar cases, are regarded as modified cases of the present exemplary embodiment and also do not deviate from the scope of the present invention. The scope and modified examples of the exemplary embodiment of the invention described above shall also apply to all exemplary embodiments described below.

### Second Exemplary Embodiment

A second exemplary embodiment of the present invention is characterized in that two thermal tuning means are included to tune a reflection band and a group delay characteristic of a waveguide Bragg grating device, and they are arranged outside a waveguide core and along the length direction of the waveguide.

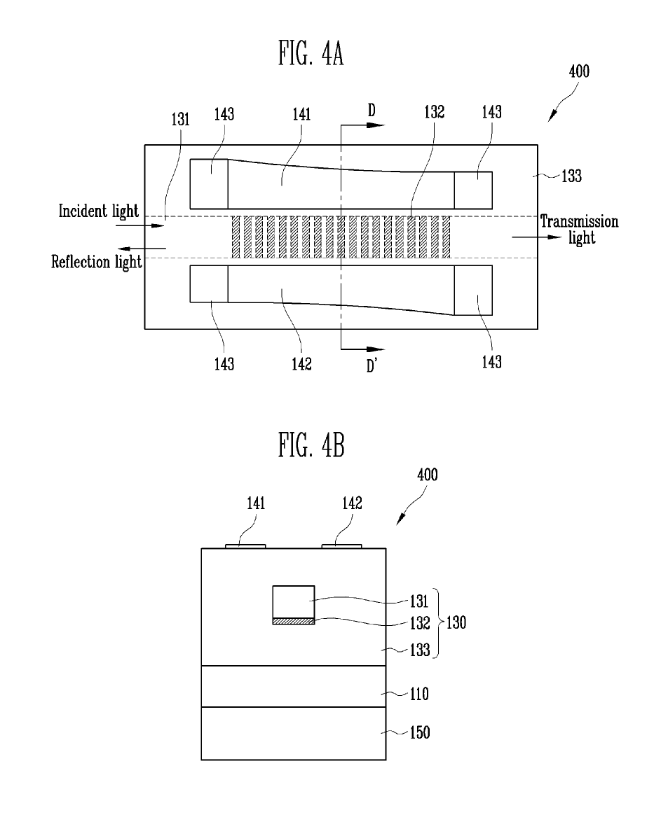

FIG. 4a is a plan view illustrating a second exemplary embodiment of a tunable waveguide Bragg grating device in accordance with the present invention, and FIG. 4b is a cross-sectional view taken along line D-D′ of FIG. 4a. The tunable waveguide Bragg grating device 400 shown in FIGS. 4a and 4b is the same as that of FIGS. 3a and 3b except that the two thermal tuning means 141 and 142 tapered in width are bisymmetrically arranged in opposite directions down the length of the waveguide core 131.

In such a structure, while a first thermal tuning means 141 generates an effect similar to the thermal tuning means 141 of FIG. 3a in tuning the reflection band and group delay characteristic of the Bragg grating device, a second thermal tuning means 142 serves to generate an opposite effect in tuning the group delay characteristic. As such, using the two thermal tuning means 141 and 142 yields the advantage of considerably widening a tunable range of the group delay characteristic, compared to the case of using only one thermal tuning means.

Although the two thermal tuning means 141 and 142 according to the present exemplary embodiment are basically applicable regardless of their shape, it is preferable to tune the group delay characteristic that at least one of the two thermal tuning means 141 and 142 is tapered. When the two thermal tuning means 141 and 142 have different taper structures, it is possible to obtain more complicated tuning feature of group delay characteristics, and a Bragg grating device having such a tuning feature can have more complicated applications such as dispersion slope compensation in optical communication. Further, it is not necessary for the two thermal tuning means 141 and 142 to be arranged on the same layer as shown in FIG. 4a, or to be detached from the central line of the waveguide core 131. Accordingly, a structure, in which one of them is arranged along or partially overlaps with the central line of the waveguide core on an upper or lower layer with respect to the waveguide core, is also included within the scope of the present exemplary embodiment. Further, the inclusion of additional thermal tuning means to complement the thermal tuning means 141 and 142 is also within the scope of the present exemplary embodiment.

### Third Exemplary Embodiment

A third exemplary embodiment of the present invention is characterized in that tunable waveguide Bragg grating devices are arranged in an array in order to provide a structure suitable for integrating multiple channels. A planar waveguide device basically has the great advantage in that an integrated optical module is constructed by an array arrangement.

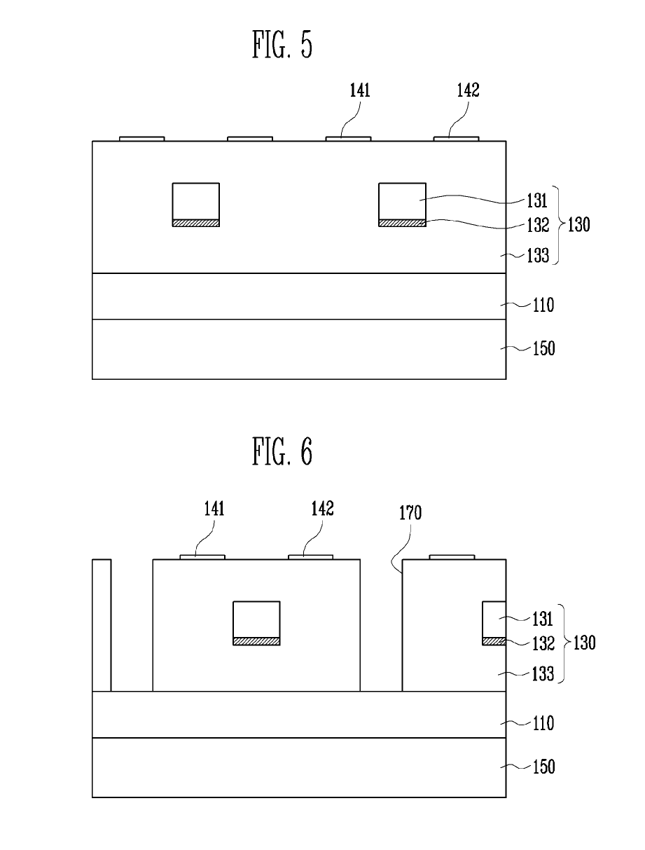

FIG. 5 is a cross-sectional view of a multiple channel tunable waveguide Bragg grating device in accordance with a third exemplary embodiment of the present invention. Since FIG. 5 is a cross-sectional view of a basic structure of a multiple channel device in which a tunable waveguide Bragg grating device according to the second exemplary embodiment is arranged in an array, a detailed description of the Bragg grating device has already been given with reference to FIGS. 4a and 4b. Referring to FIG. 5, the array format corresponds to a structure in which the tunable waveguide Bragg grating devices 400 disclosed in the second exemplary embodiment are repeatedly arranged from left to right. As such, it is easy to generate an integrated optical module having a multiple channel structure by repeatedly arranging the Bragg grating device from left to right.

### Fourth Exemplary Embodiment

In the structure of the multiple channel tunable waveguide Bragg grating device in accordance with the third exemplary embodiment, thermo-optic effects generated by the thermal tuning means for a channel can also affect adjacent channels. A structure of a multiple channel device devised to solve this problem is shown in FIG. 6. Since FIG. 6 shows a modified example of the multiple channel tunable waveguide Bragg grating device according to the third exemplary embodiment of the present invention, a detailed description of elements shown in FIG. 6 can be found in the above descriptions of other exemplary embodiments. FIG. 6 illustrates a structure in which a trench structure is added between channels constructing the multiple channel tunable Bragg grating device of FIG. 5. In this case, it is basically possible to avoid thermal crosstalk. Additionally, it can be achieved to reduce birefringence caused by the strain-stress effect in the waveguide device 130 and to increase the tuning efficiency by the thermal tuning means. Such a multiple channel device structure can be widely applied to various types of multiple channel thermo-optic tunable devices as well as the tunable waveguide Bragg grating device.

Although the proceeding exemplary embodiments generally describe a structure in which one or two thermal tuning means are arranged for one waveguide Bragg grating region 130, various extended cases are also included in the scope of the present invention. For example, a number of thermal tuning means can have their respective shapes with respect to their width, thickness and length, and also, some of them can have the same shape and be arranged in the same or opposite directions,

As described above, a reflection band and a group delay characteristic of a waveguide Bragg grating device of the present invention can be tuned in a variety of ways.

Further, the present invention has the advantage of enabling a multiple channel tunable waveguide Bragg grating device to be embodied efficiently by arranging individual waveguide Bragg grating devices in an array.

Furthermore, it is possible to effectively prevent thermal crosstalk between neighboring channels by forming a trench structure in the multiple channel waveguide Bragg grating device.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A tunable waveguide Bragg grating device, comprising:
a waveguide through which incident light can travel;
a Bragg grating formed in at least one region of the waveguide; and
at least one thermal tuning means formed at a position displaced from the central line of a waveguide core along the length direction of the waveguide core.

2. The tunable waveguide Bragg grating device according to claim 1, wherein the waveguide core has a structure of fixed width and height, or a tapered structure of changing width or height in the length direction of the waveguide core.

3. The tunable waveguide Bragg grating device according to claim 1, wherein the Bragg grating is formed inside the waveguide or in a region where an optical mode traveling in the waveguide can be coupled.

4. The tunable waveguide Bragg grating device according to claim 3, wherein the Bragg grating has a uniform period.

5. The tunable waveguide Bragg grating device according to claim 3, wherein the Bragg grating has a period chirp along its length direction.

6. The tunable waveguide Bragg grating device according to claim 3, wherein an apodization is employed at at least one end of the Bragg grating.

7. The tunable waveguide Bragg grating device according to claim 1, wherein the thermal tuning means is a thin film heater.

8. The tunable waveguide Bragg grating device according to claim 1, wherein the thermal tuning means has a structure of fixed width and height, or a tapered structure of changing width or height in the length direction of the waveguide core.

9. The tunable waveguide Bragg grating device according to claim 1, wherein there are plural thermal tuning means, and at least one pair of the thermal tuning means have the same taper structure and are arranged in opposite directions with respect to the length direction of the waveguide core.

10. The tunable waveguide Bragg grating device according to claim 1, wherein there are plural thermal tuning means, and each of the thermal tuning means has different taper structures and is arranged along the length direction of the waveguide core.

11. The tunable waveguide Bragg grating device according to claim 1, wherein at least one of the thermal tuning means is formed on a different layer than the waveguide core such that it can be viewed to at least partially overlap the waveguide core.

12. The tunable waveguide Bragg grating device according to claim 1, further comprising a temperature control means arranged on a different layer than the thermal tuning means to control the overall temperature of the Bragg grating device.

13. A multiple channel tunable waveguide Bragg grating device, comprising a multiple channel structure formed by arranging the tunable waveguide Bragg grating devices according to claim 1 in an array.

14. The multiple channel tunable waveguide Bragg grating device according to claim 13, further comprising a trench structure formed between channels.
